(19) United States
(12) Patent Application Publication
(10) Pub. No.: US 2018/0353908 A1
(43) Pub. Date: Dec. 13, 2018

(54) TUBULAR FILTER MEMBRANE ELEMENT AND METHOD FOR THE PRODUCTION THEREOF

(71) Applicant: KRALLMANN KUNSTSTOFFVERARBEITUNG GMBH, Hiddenhausen (DE)

(72) Inventors: Kai AUFDERHEIDE, Bünde (DE); Wiebe VAN DRUTEN, AE Wageningen (DE); Albert OPPERS, AH Er (NL)

(21) Appl. No.: 15/778,814

(22) PCT Filed: Nov. 23, 2016
(86) PCT No.: PCT/EP2016/001972

§ 371 Date: May 24, 2018

(30) Foreign Application Priority Data
Nov. 25, 2015 (DE) 10 2015 015 159.2

(51) Int. Cl. B01D 63/06; B01D 61/14; B01D 61/18; B01D 65/00; B01D 69/04; B01D 63/02; B01D 69/08; B29C 57/10; B29C 45/14; B29C 69/02; B29C 45/00

(52) U.S. Cl. CPC B01D 63/061; B29L 2031/14; B01D 61/18; B01D 65/003; B01D 69/04; B01D 63/024; B01D 63/021; B01D 69/08; B29C 57/10; B29C 45/14065; B29C 69/02; B29C 45/0046; B01D 2313/13; B29C 2045/14139; B29C 2045/0049; B01D 61/147

(57) ABSTRACT

In order to produce a tubular filter membrane element for microfiltration purposes, a plastic section of a small membrane tube is sealed at one axial end thereof and is fitted with a plastic adapter piece at the opposite end. The adapter piece is injection-molded onto the section of the small membrane tube and is preferably welded thereto. The section of the small membrane tube is sealed at the one axial end thereof by bringing this end into contact with a hot stamp.

### CROSS REFERENCE TO RELATED APPLICATIONS

This application is a United States National Phase Application of International Application PCT/EP2016/001972, filed Nov. 23, 2016, and claims the benefit of priority under 35 U.S.C. § 119 of German Application 10 2015 015 159.2, filed Nov. 25, 2015, the entire contents of which are incorporated herein by reference.

### FIELD OF THE INVENTION

The present invention pertains to a filter membrane element for microfiltration, with a membrane tube section consisting of plastic, which is sealed at one axial end thereof and has an adapter piece consisting of plastic at its opposite axial end.

The present invention further pertains to a method for producing a corresponding tubular filter membrane element.

### BACKGROUND OF THE INVENTION

In microfiltration, particles are separated predominantly on the surface of a porous membrane. The membrane has pores or passages of a very small diameter, so that the particles to be separated cannot pass through the membrane. The fluid phase of a suspension to be filtered can then flow through the membrane, while the particles are retained.

As an alternative, a corresponding membrane may also be used to distribute a fluid flow, for example, an air flow, into a plurality of individual flows, which is advantageous, for example, when foaming in a liquid, especially milk. It will hereinafter be assumed as an example that the membrane is used for microfiltration, but the present invention is not limited to this.

Tubular membranes are frequently used in so-called dynamic microfiltration. A tubular filter membrane element is sealed at one of its axial ends and is provided with a prefabricated adapter piece made of plastic at its opposite axial end. The adapter piece may be, for example, a connection sleeve for a fluid line or another functional part necessary for the use of the filter membrane element. The suspension to be filtered may be introduced either into the interior of the tubular filter membrane element, in which case the fluid phase of the suspension flows through the wall of the filter membrane element and is removed on the outer side thereof, while the particles remain in the filter membrane element. However, a reversed flow is frequently preferred, i.e., the suspension to be filtered is located on the outside of the tubular filter membrane element and the fluid phase passes through the wall of the filter membrane element, enters the interior thereof and is removed from there, while the particles filtered out remain outside the filter membrane element.

Depending on the size and especially the internal diameter of the tubular filter membrane element, this is also called capillary membrane or, in case of very small internal diameter, also hollow fiber membrane.

The flow rate through an individual tubular filter membrane element is low due to the very small dimensions, so that it is common practice to combine a plurality of tubular filter membrane elements into a so-called filter membrane module. Each filter membrane element is provided with an adapter piece here. Since the adapter pieces must be placed one by one on a membrane tube section, the production of a filter membrane element and especially of a filter membrane module comprising many filter membrane elements is very complicated and costly. Moreover, it must be ensured that the prefabricated adapter piece is placed securely and in a sealed manner on the membrane tube section, and complicated quality controls are therefore necessary.

The membrane tube section of each individual filter membrane element must be sealed manually at one end. This is also very complicated and therefore costly. Moreover, it must be ensured that the membrane tube section is sealed reliably at its end, so that no short-circuit flow will develop. This also requires a complicated quality control.

It is known from DE 10 2005 004 372 A1 that a prefabricated membrane tube is inserted into an injection mold and is provided with an end-side, dimensionally stable plastic part there, which is injection-molded onto the membrane tube. Nothing is stated concerning the sealing of the membrane tube section at the axially opposite end.

### SUMMARY OF THE INVENTION

A basic object of the present invention is to provide a method for producing a tubular filter membrane element especially for microfiltration, with which an end section of the membrane tube section, which is to be sealed, can be sealed reliably and in a simple manner. Moreover, a filter membrane element, in which good flow characteristic is ensured, shall be provided.

With respect to the method, the above object is accomplished by a method having the features according to the invention. Provisions are made here for the membrane tube section to be sealed at one of its axial ends by being brought into contact with this end with a hot punch and by being formed into a desired shape.

To produce the membrane tube section, a section having a predefined length is cut off from a membrane tube strand, i.e., a so-called endless material of a flexible tube consisting of plastic, which has a wall having a desired permeability, for example, a microperforation. This section having a predefined length is at first open at both of its axial ends. The membrane tube section is now sealed at one of its axial ends by being brought into contact with a hot punch at this end. The hot punch may be a metallic component provided with a shaping contour, which is brought to a temperature at which the material of the membrane tube section begins to melt and becomes deformable to the extent that it is sealed in a fluid-tight manner by pressing or compression. The axial end of the membrane tube section is additionally now formed into a desired shape, for example, a shape tapering in the axial direction.

The term “axial” pertains within the framework of this description to the longitudinal axis of the membrane tube section, while the term “radial” defines a direction at right angles thereto.

The membrane tube section is preferably positioned on a mandrel during the sealing of its axial end, while the sealing is carried out by means of the hot punch.

The end of the membrane tube section, which end is to be sealed, is preferably inserted into a recess of the hot punch, said recess preferably having a shape complementary to the desired shape of the sealed axial end. For example, the recess may have a conically recessed shape, especially one ending in a point. It is possible in this manner to form a shape tapering conically in the axial direction on the membrane tube section at the sealed end thereof.

Provisions may be made in a possible variant of the present invention for the membrane tube section to rotate about its longitudinal axis or to be pivoted during the sealing of the axial end and especially during the meshing with the recess of the hot punch. The membrane tube section can be prevented in this manner from adhering to the surface of the hot punch.

As an alternative or in addition to this, provisions may be made for the hot punch to be rotated or pivoted during the sealing of the axial end of the membrane tube section.

The adapter piece is preferably not prefabricated and placed on the likewise prefabricated membrane tube section later, but the preparation of the adapter piece and the placement thereof on the membrane tube section may be carried out in a common method step by the adapter piece being injection-molded onto the membrane tube section. Not only a very rapid and cost-effective production of the tubular filter membrane element is possible in this manner, but it is also ensured that uniform quality is ensured for the connection between the adapter piece and the membrane tube section.

The membrane tube section is prefabricated and then inserted into a cavity of an injection molding device. Provisions may now be made for the membrane tube section to be arranged on a positioning mandrel or to be placed on same. The placement on the positioning mandrel may be carried out outside the injection molding device, after which the positioning mandrel with the membrane tube section attached is then inserted into the injection molding device. It is, however, also possible as an alternative for the positioning mandrel to be arranged in the injection molding device and for the membrane tube section to be placed on this.

The membrane tube section is held by the positioning mandrel during the injection molding operation, i.e., it is prevented from moving within the cavity of the injection molding device. The membrane tube section is preferably seated with a close fit on the positioning mandrel. Provisions may be made in one possible embodiment for the external diameter of the positioning mandrel to be slightly greater than the internal diameter of the membrane tube section, so that the membrane tube section is placed on and held on the positioning mandrel with a slight elastic radial deformation. The axial positioning of the membrane tube section on the positioning mandrel is preferably carried out by means of a stop.

Provisions are made in a preferred embodiment of the present invention for the positioning mandrel to have a receiving section, onto which the membrane tube section is pushed, and an enlarged mandrel section, which is arranged axially offset in relation thereto. The enlarged mandrel section has an enlarged diameter compared to the receiving section, and a step, which acts as a stop for the axial positioning of the membrane tube section on the positioning mandrel, is preferably formed between the receiving section and the enlarged mandrel section.

After the membrane tube section has been inserted into the cavity of the injection molding device and the latter is closed, a plastic melt is introduced into the cavity through a feed channel in the usual manner. Provisions may be made according to the present invention for the opening of the feed channel to be oriented such that the jet of plastic melt leaving the opening of the feed channel to reach the positioning mandrel at a spaced location from the membrane tube section rather than the membrane tube section. The injection pressure or the dynamic loads developing as a consequence of the plastic melt being fed is prevented in this manner from damaging the very thin and hence delicate membrane tube section.

The plastic melt may be injected into the cavity radially in relation to the longitudinal axis of the positioning mandrel or of the membrane tube section, which causes the plastic melt to reach directly the positioning mandrel and especially the enlarged section of the mandrel. The positioning mandrel can absorb the punctiform loads occurring in the process without problems and it further causes the plastic melt to be deflected, without causing excessive stress of the membrane tube section.

As an alternative to this, provisions may be made for the plastic melt not to be applied exactly radially, i.e., directed directly toward the longitudinal axis of the positioning mandrel, but with an offset thereto and especially tangentially.

Provisions may be made in a variant of the present invention for the feed channel to be divided upstream of its opening in the cavity into at least two branch channels. The feed channel does not have a single opening in the cavity in this case, but the plastic melt is introduced with a parallel flow orientation into the cavity through the branch channels due to the division into the branch channels. On the one hand, excessively high punctiform stresses can be avoided in this manner during the introduction of the plastic melt, and, on the other hand, it is ensured due the division into a plurality of branch channels that the cavity is filled with the plastic material reliably and completely.

Provisions are made in a preferred embodiment of the present invention for the adapter piece to be welded to the membrane tube section. Welding means in the sense of the present invention that the plastic materials and the method parameters are coordinated with one another such that the plastic material of the membrane tube section and the plastic material of the adapter piece form a molecular connection, which leads to an inseparable connection of the two parts in substance, during the injection molding process.

The above object is accomplished with respect to the filter membrane element by the membrane tube section having a conically tapering shape in the axial direction at its sealed end. A shape of the membrane tube section tapering conically to a point at the end thereof that is sealed by means of the hot punch proved to be advantageous, on the one hand, for avoiding an accumulation of fluid in the interior of the membrane tube section to the extent possible and, on the other hand, for guaranteeing a good flow of fluid.

The adapter piece may be injection-molded onto the membrane tube section and welded to same.

The adapter piece may be a connection sleeve for a fluid line.

Further details and features of the present invention can be found in the following description of an exemplary embodiment with reference to drawings.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a longitudinal view through a filter membrane element;

FIG. 2 is a first phase of the preparation of a membrane tube section;

FIG. 3 is a second phase of the preparation of the membrane tube section;

FIG. 4 is a third phase of the preparation of the membrane tube section;

FIG. 5 is a fourth phase of the preparation of the membrane tube section;

FIG. 6 is a vertical section through an injection molding device after introduction of the plastic melt; and

FIG. 7 is section VII-VII in FIG. 6.

### DESCRIPTION OF THE PREFERRED EMBODIMENTS

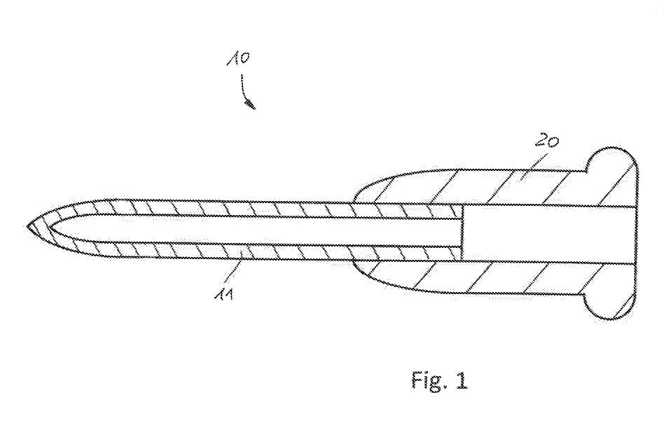

Referring to the drawings, FIG. 1 shows a tubular filter membrane element 10 for microfiltration. The filter membrane element 10 has a membrane tube section 11 consisting of plastic, which is sealed at one of its ends, at the left-hand axial end according to FIG. 1, forming a shape tapering conically in the axial direction, and which is connected at its opposite end, at the right-hand end according to FIG. 1, to an adapter piece 20 consisting of plastic which forms a connection sleeve for a fluid line. The membrane tube section 11 consists of a permeable plastic material, wherein the permeability may be formed by a basic porosity of the material and/or by a subsequently prepared perforation.

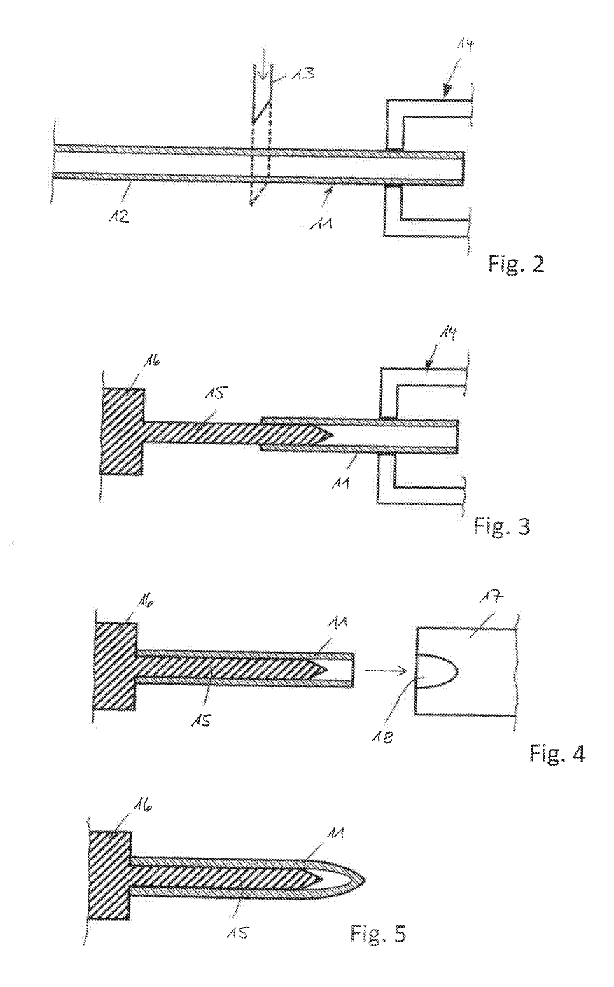

The preparation of the tubular filter membrane element 10 will be explained below in individual steps on the basis of FIGS. 2 through 7.

The material of which the membrane tube section 11 consists is a flexible membrane tube strand 12, i.e., a so-called “endless” material. The membrane tube strand 12 is gripped and fixed at its free end by means of a gripper 14, suggested only schematically, after which a membrane tube section 11 having a predefined length is cut off from the membrane tube strand 12 by means of a knife 13.

The membrane tube section 11 is gripped, further, by means of the gripper 14 and is pushed by this onto a pin-like mandrel 15 until the end of the membrane tube section 11 facing away from the gripper contact with a stop 16 of the mandrel 15. The membrane tube section 11 is held on the mandrel 15 by friction and optionally while undergoing elastic deformation. This state is shown in FIG. 3.

The free axial end of the membrane tube section 11 facing away from the stop 16 is then brought into contact with a hot punch 17, which has a conical or semi-ellipsoidal recess 18, as it is suggested by the arrow in FIG. 4. The hot punch 17 is heated to a temperature that softens the material of the membrane tube section 11 and melts it at least partially. Due to the free end of the membrane tube section being pressed into the recess 18 of the hot punch 17, this end of the membrane tube section 11 is sealed, on the one hand, and shapes it at the same time to a desired contour, for example, a contour ending in a point, as it is shown in FIG. 5.

While the axial end of the membrane tube section 11, which end is to be sealed, is in contact with the recess 18 of the hot punch, the mandrel 15 together with the membrane tube section 11 and/or the hot punch 17 are rotated or pivoted about the longitudinal axis of the membrane tube section 11 in order to prevent the membrane tube section 11 from adhering to the hot punch 17.

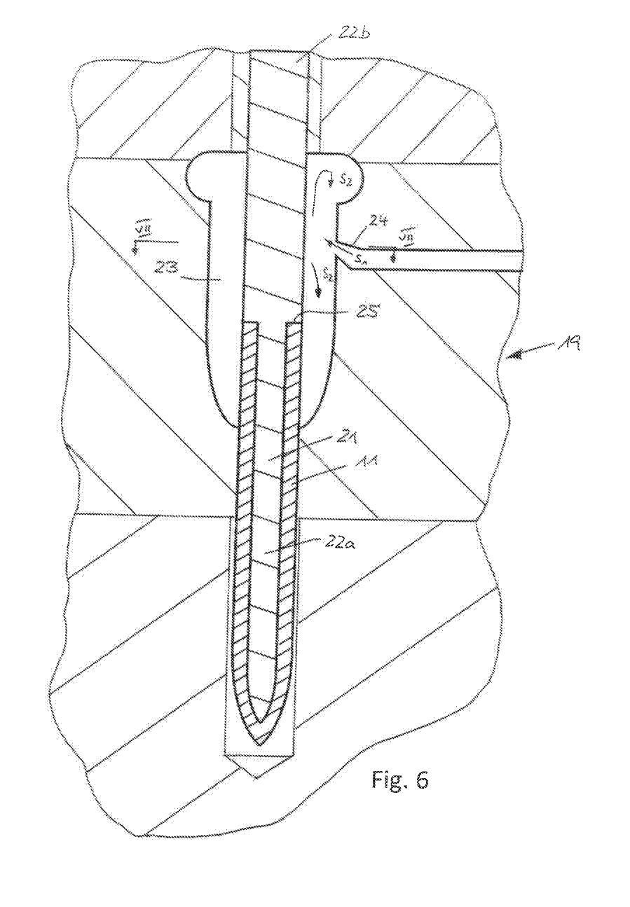

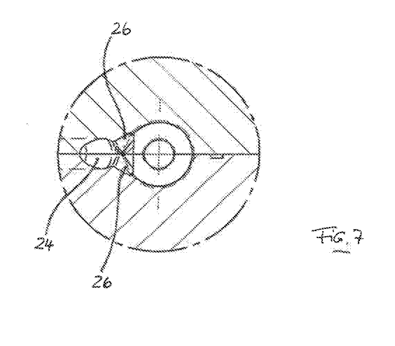

The prefabricated membrane tube section 11, sealed at one axial end, is then inserted into an injection molding device 19, as it is schematically shown in FIG. 6. The injection molding device 19 has a pin-like positioning mandrel 21, which has an end-side receiving section 22a, onto which the membrane tube section 11 is pushed while the latter undergoes elastic widening. The receiving section 22a of the positioning mandrel 21 is adjoined by an enlarged mandrel section 22b, which has an enlarged external diameter, and a step, which forms a stop 25, which is struck by the open end of the membrane tube section 11, is formed in the transition area between the receiving section 22a and the enlarged mandrel section 22b.

After closing the injection molding device 19, the end area of the membrane tube section 11, which end area is located opposite the sealed axial end, and the area adjoining same around the enlarged mandrel section 22b of the positioning mandrel 21 are surrounded by a mold cavity or a cavity 23. A feed channel 24 for a plastic melt opens into the cavity 23. As is shown in FIG. 7, the feed channel 24 is divided directly in front of the opening into the cavity 23 into two branch channels 26, which open each into the cavity 23.

It is suggested in FIG. 6 that the opening of the feed channel 24 or of the branch channels 26 is oriented such that the plastic melt entering the cavity 23 through the opening does not reach directly the membrane tube section 11, but the outer side of the enlarged mandrel section 22b of the positioning mandrel 21, as is suggested by the arrow S1. The plastic melt rebounds from there and is distributed in the cavity 23, as it is suggested by the arrows S2.

The plastic melt is welded to the plastic material of the membrane tube section 11 and is firmly connected to same via a molecular bond.

After opening the injection molding device 19, the filter membrane element 10 shown in FIG. 1, in which the interior of the membrane tube section 11 is accessible through the sleeve-like adapter piece 20, is formed.

While specific embodiments of the invention have been shown and described in detail to illustrate the application of the principles of the invention, it will be understood that the invention may be embodied otherwise without departing from such principles.

1. A method for producing a tubular filter membrane element for microfiltration, the method comprising the steps of:
sealing a membrane tube section consisting of plastic at one axial end of the membrane tube section to provide a sealed axial end; and
providing an adapter piece consisting of plastic at another axial end of the membrane tube section, which is opposite to the sealed axial end, wherein the step of sealing comprises sealing the one axial end by contacting the one axial end with a hot punch forming the one axial end into a desired shape.

2. A method in accordance with claim 1, wherein the membrane tube section is positioned on a mandrel during the sealing of the one axial end.

3. A method in accordance with claim 1, wherein the one axial end of the membrane tube section is inserted into a recess of the hot punch.

4. A method in accordance with claim 1 wherein a shape tapering conically in the axial direction is formed at the sealed axial end of the membrane tube section.

5. A method in accordance with claim 1, wherein the membrane tube section is rotated or pivoted about a longitudinal axis thereof during the step of sealing the one axial end.

6. A method in accordance with claim 1, wherein the hot punch is rotated or pivoted during the step of sealing the one axial end of the membrane tube section.

7. A method in accordance with claim 1, wherein the adapter piece is injection-molded onto the membrane tube section.

8. A method in accordance with claim 7, wherein the membrane tube section is arranged on a positioning mandrel in a cavity of an injection molding device and is held by the positioning mandrel during the injection molding.

9. A method in accordance with claim 8, wherein the membrane tube section is seated with a close fit on the positioning mandrel.

10. A method in accordance with claim 8, wherein the positioning mandrel has a receiving section, onto which the membrane tube section is pushed, and an enlarged mandrel section, which is arranged axially offset in relation thereto.

11. A method in accordance with claim 8, wherein a plastic melt is introduced into the cavity through a feed channel, wherein the opening of the feed channel is oriented such that the plastic melt reaches the positioning mandrel at a spaced location from the membrane tube section.

12. A method in accordance with claim 11, wherein the plastic melt reaches the enlarged mandrel section.

13. A method in accordance with claim 11, wherein the feed channel is divided into at least two branch channels upstream of the opening in the cavity.

14. A method in accordance with claim 1, wherein the adapter piece is welded to the membrane tube section.

15. A filter membrane element comprising:
a membrane tube section consisting of plastic, which is sealed at one axial end by contacting the one axial end with a hot punch to form a desired shape sealed axial end; and
an adapter piece consisting of plastic at another axial end of the membrane tube section, which is opposite to the desired shape sealed axial end, wherein the desired shape is such that the membrane tube section has a shape tapering conically in an axial direction at the desired shape sealed axial end.

16. A filter membrane element in accordance with claim 15, wherein the adapter piece is injection-molded to the membrane tube section and is welded to same.

17. A filter membrane element in accordance with claim 1, wherein the adapter piece is a connection sleeve for a fluid line.
